(19) United States
(12) Patent Application Publication
(10) Pub. No.: US 2011/0099755 A1
(43) Pub. Date: May 5, 2011

(54) Hinge

(76) Inventor: Gunter Reichel, Dauphtal (DE)

(21) Appl. No.: 10/549,627

(22) PCT Filed: Mar. 17, 2004
(86) PCT No.: PCT/EP2004/002755

§ 371 Date: Jul. 7, 2006

(30) Foreign Application Priority Data
Mar. 21, 2003 (DE) 203 04 646.3

(51) Int. Cl. E05D 11/00; E05D 5/02; E05D 1/06

(52) U.S. Cl. 16/251; 16/382; 16/260

(57) ABSTRACT

The invention relates to a fitting for shower partition parts made of a flat material such as, glass, plastic or similar. The door elements thereof have bores which are arranged in the vicinity of a high edge in order to receive hinge plate parts. The fitting has three main components. A stationary hinge member is provided that is adapted to be fixed in the borehole of a stationary door member, and which is also adapted to receive a shiftable hinge housing with a lower sleeve unit. A hinge leaf member is provided that is adapted to be fixed to a moveable door leaf. The hinge leaf member has an upper sleeve member adapted to interlock with the lower sleeve member to allow the hinge leaf member to run on the stationary hinge member. The hinge leaf member is height adjustable within a limited range.

The present invention relates to a hinge according to the preamble of claim 1, in particular for use for shower screens with glass doors. Such hinges are mainly designed to be attached to room enclosure devices, in particular shower enclosure units, comprising at least one stationary door element and at least one door leaf adjacent the latter, consisting of flat material such as glass, plastics or the like, and having boreholes close to a vertical edge to receive door hinge parts.

In diverse fields of art and also in the field of bathroom equipments, full glass elements have gained more and more popularity in recent times. They provide an unhindered view and are particularly popular as frameless room enclosure devices due to their smooth structure that makes them shapely and easy to clean. The heaviness of rotating and swinging glass panels requires special door fittings or hinges to ensure their reliable functioning in spite of permanent heavy duty and frequently changing operational demands. Generally, they are fastened to and in boreholes, respectively, that are provided in the glass close to a vertical edge area, and that in many cases are improperly drilled. It is imperative to compensate high load moments in order to prevent a door from leaning sideways, which would make it difficult to open and close it. Therefore, the structure and the mounting possibilities of the fastening means must meet enormous requirements.

It is an important object of the present invention to avoid the aforesaid drawbacks by providing a door hinge that reliably permits to be fastened particularly to glass partition walls, especially to such of a shower enclosure, in a way that provides durable functioning. It is intended to ensure an easy and reliable mounting that offers the possibility to make readjustments in several directions. The hinge shall have an attractive design and be easy to clean.

The main features of the invention are declared in claim 1. Embodiments form the subject matter of claims 2 to 22.

The present invention provides, according to claim 1, a hinge of the aforementioned type, characterized in that:
a) a stationary hinge member comprises an end-stop clamping plate with a support body which has or constitutes a two-dimensionally adjustable bearing for a first clamping disk adapted to be fixed in a borehole of a stationary door element, and on which a hinge housing member, forming a single unit with a lower sleeve member or being rigidly connected with the latter, is adapted to be placed and shifted within a limited range,
b) a hinge-leaf member comprises a base with a recess to receive in a form-fitting manner projections of a second clamping disk adapted to be fixed in a borehole of a door leaf, and additionally comprises an upper sleeve member that forms a single unit with the base or is rigidly connected with the latter,
c) the hinge-leaf member, running on the stationary hinge member, is height adjustable within a limited range, with the lower sleeve member and the upper sleeve member interlocking with their parts that face each other.

Such a hinge consists of only three main components and units, respectively, and constitutes an extremely solid door hinge construction suitable to be pre-assembled as well as readjusted. That permits not only a quick and comfortable, properly adjusted mounting on the spot but also an easy and accurate readjustment, if such should be necessary. Furthermore, it permits a very flat construction that can be realized by attractive designs of manifold types.

In an advantageous embodiment, the end-stop clamping plate and the hinge housing member are connected by means of a detachable guiding device, e. g. a dovetail guide, to form a shiftable unit, with the support body preferably being an undercut broad rib which protrudes the end-stop clamping plate and to which undercut guide edges of the hinge housing member are attached. In this way, it is easily adjustable in horizontal direction.

The end-stop clamping plate may be rectangular and comprise on one of its narrow edges a ledge, a fold or the like that sits close to a vertical edge of the stationary door element during and after the mounting, ensuring thus the exact orientation of the stationary housing member. The fold, directing away from the support body side of the end-stop clamping plate, may have the additional function of a stopper that limits the pivoting range of the hinge leaf member.

In a convenient embodiment, the support body comprises an oblong recess that is adapted to receive in a selectable position an adjustment excenter screwed with the first clamping disk, for which purpose said support body may be provided with at least one radial screw, e. g. a headless set screw, to be wedged against the circumference of the adjustment excenter. Rotating and shifting said adjustment excenter on the spot permits a rough and a fine adjustment both in height and in width, which ensures an optimal fastening of the clamping plate.

In addition to the oblong recess, the support body comprises in a further development clamping means for fixing the hinge housing member that may consist of at least one screw positioned in the support body in vertical direction to the plane of the latter, and that are mountable and detachable, e. g. by applying tools through the hinge housing member. For this purpose, said hinge housing member may comprise two parallel oblong holes opposite the heads of two screws. As soon as the exact adjustment position has been determined, the fully screwed-in screws are loosened, with their screw heads permitting thus the support body and the housing member to clamp together and to get firmly fixed. A cover means, especially in form of a detachable and removable cap, serves to protect the hinge housing member.

Another development provides the hinge leaf member to be adapted to engage, with respect to the stationary hinge member, in preferred pivoting positions, which helps to make door operation much easier. For this purpose, the hinge housing member advantageously comprises in the lower sleeve member a ribbed collar that interengages with projections of an interlocking means located in the upper sleeve member that may particularly be a cylindrical element, positioned in the upper sleeve member and provided with in downward direction axially aligned projections. The function of this construction is both simple and trouble-free. When the door leaf is pivoted, the interlocking means and consequently the upper sleeve member rise to the end of high bottom ribs. When the pivoting movement continues, it engages in the somewhat lower intermediate ribs that define preferred angle positions of the door leaf.

The interlocking means may be attached to a disk that is placed in the upper sleeve member in a way that permits rotations within a limited range around the axis of the latter, for example by attaching it to an inner transverse wall provided with oblong holes in the bottom segment which constitute angle stops for fixation screws that penetrate the interlocking means parallel to its axis. That permits to adjust the hinge leaf member to its locally most convenient position.

Yet a further embodiment provides the stationary hinge member and the hinge leaf member to be connected in a detachable manner through an axial retaining means which may be composed of a center pin that forms a single unit with the lower sleeve member or is rigidly connected with the latter, with said center pin having a tapped blind hole on the front side to receive a screw that penetrates the transverse wall in the upper sleeve member. This central pin may constitute an additional guiding device for the lower sleeve member and the upper sleeve member. The axial retaining means prevents the door leaf in a simple way from accidental disconnection.

The reliability of the sliding bearing of the housing member and the leaf member can be increased by reducing the clearance of the axial interengagement of the sleeve collars of the lower sleeve member and the upper sleeve member, which permits the exact definition of the rotation and pivoting axis.

The accuracy of fastening the hinge components is substantially improved by the fact that each of the clamping disks comprises a cylindrical section, located in the related borehole of the stationary door element and the door leaf, and an axially adjacent conical collar to be inserted into form-fitting countersinkings that ensure exact form fit and tight fit in the borehole.

Other features, details and advantages of the invention will be evident from the wording of the claims and the following description of embodiments by way of the drawings, wherein:

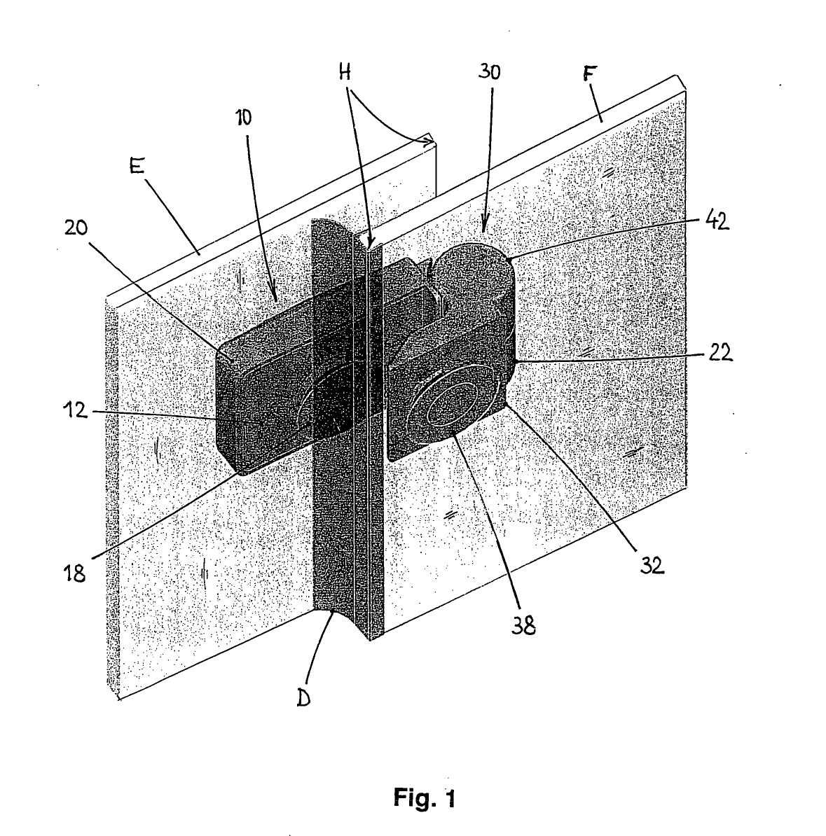

FIG. 1 is an oblique partial view of glass door elements, taken from inside and from the back, respectively, with an hinge according to the present invention in closed position,

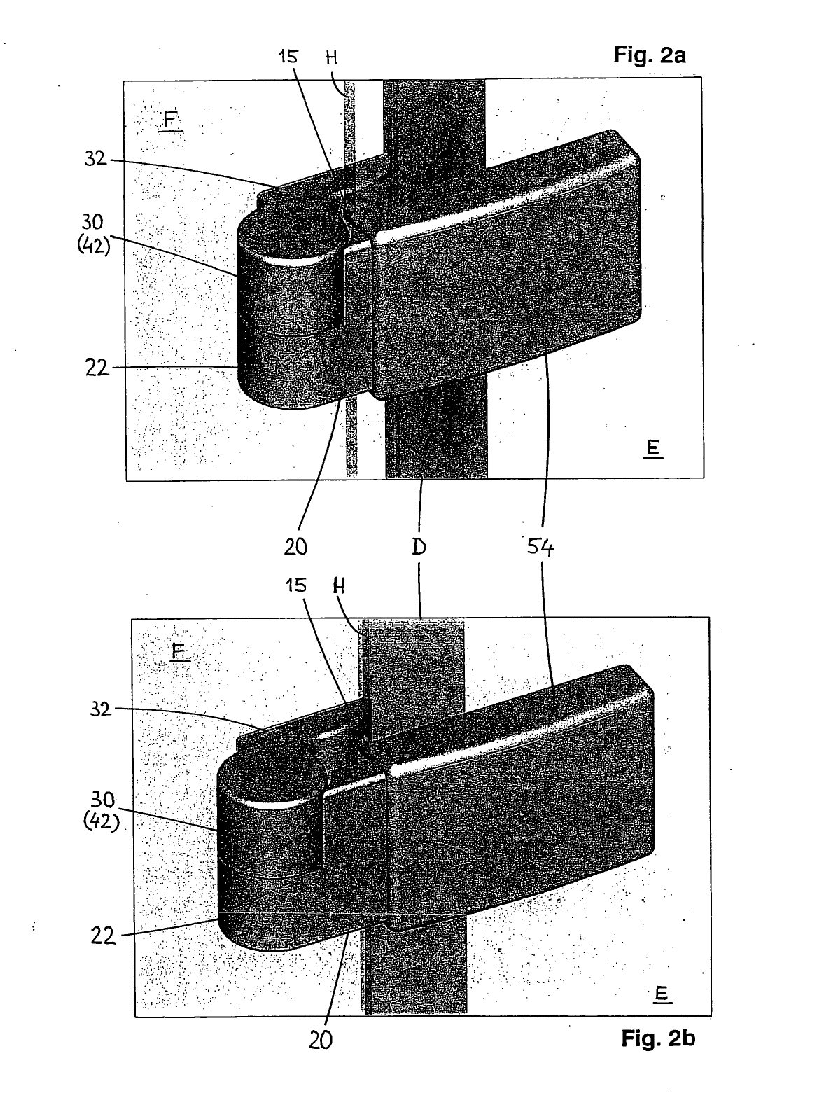

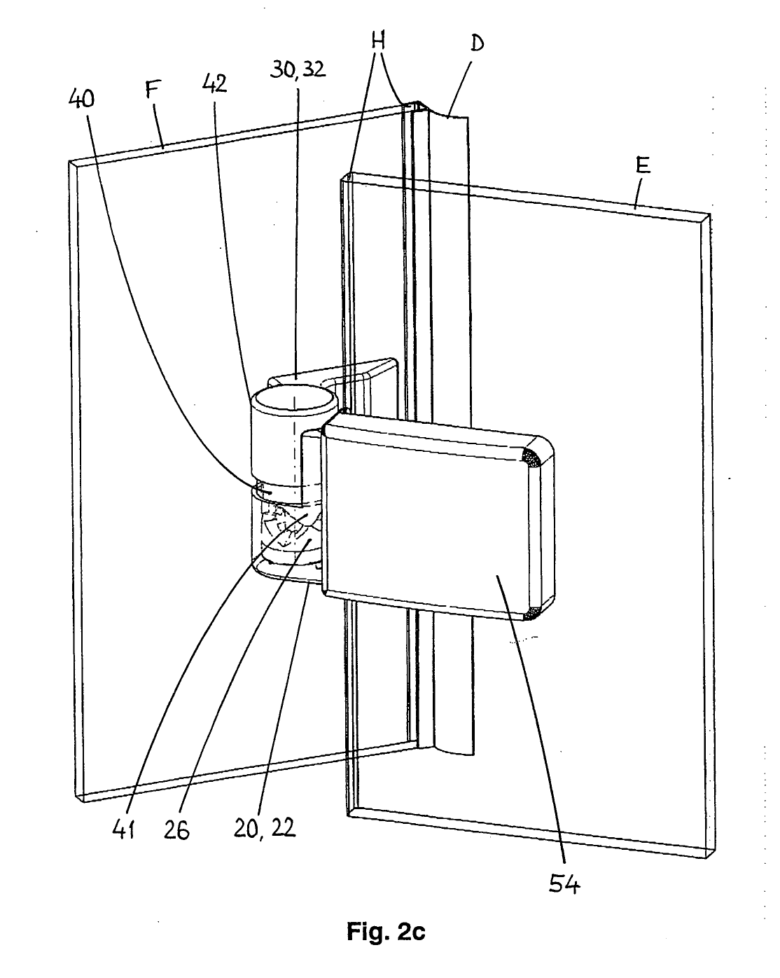

FIG. 2a is an oblique partial view of glass door elements, taken from outside and from the front, respectively, with an hinge in closed position,

FIG. 2b is an oblique partial view according to FIG. 2a, yet in another adjustment position,

FIG. 2c is an oblique partial view of glass door elements, taken from outside and from the front, respectively, with an hinge in opened position,

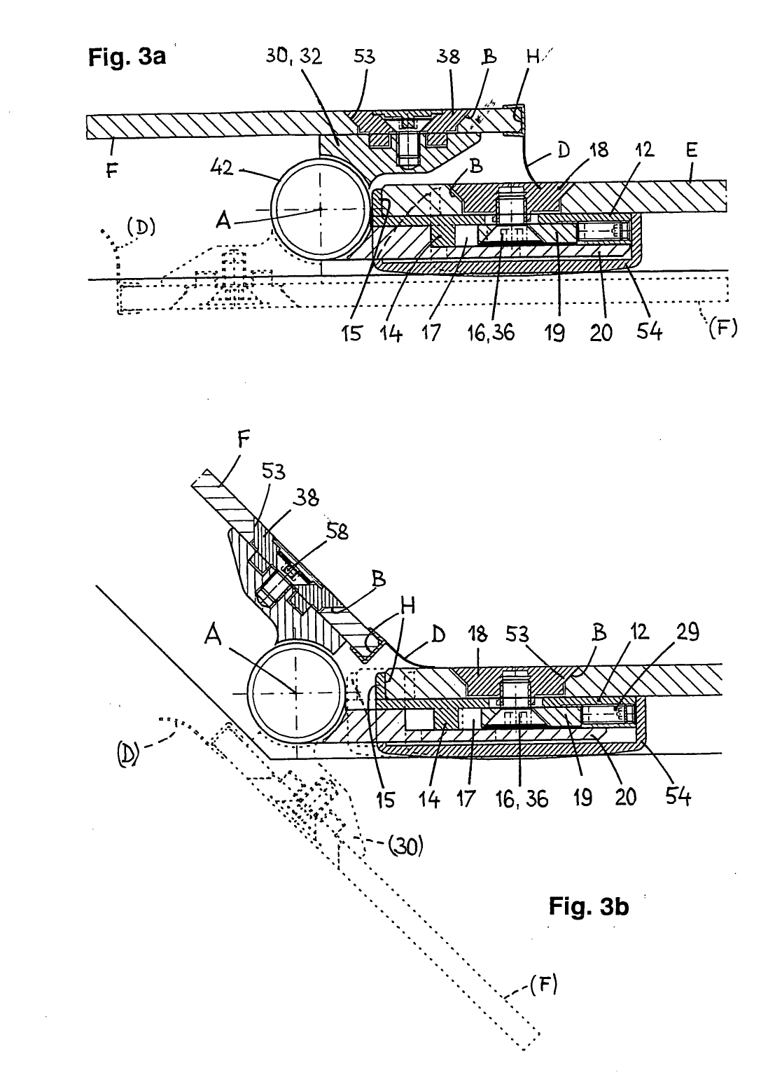

FIG. 3a is a horizontal cross section through a hinge in closed position,

FIG. 3b is a horizontal cross section through a hinge in another adjustment position and opened,

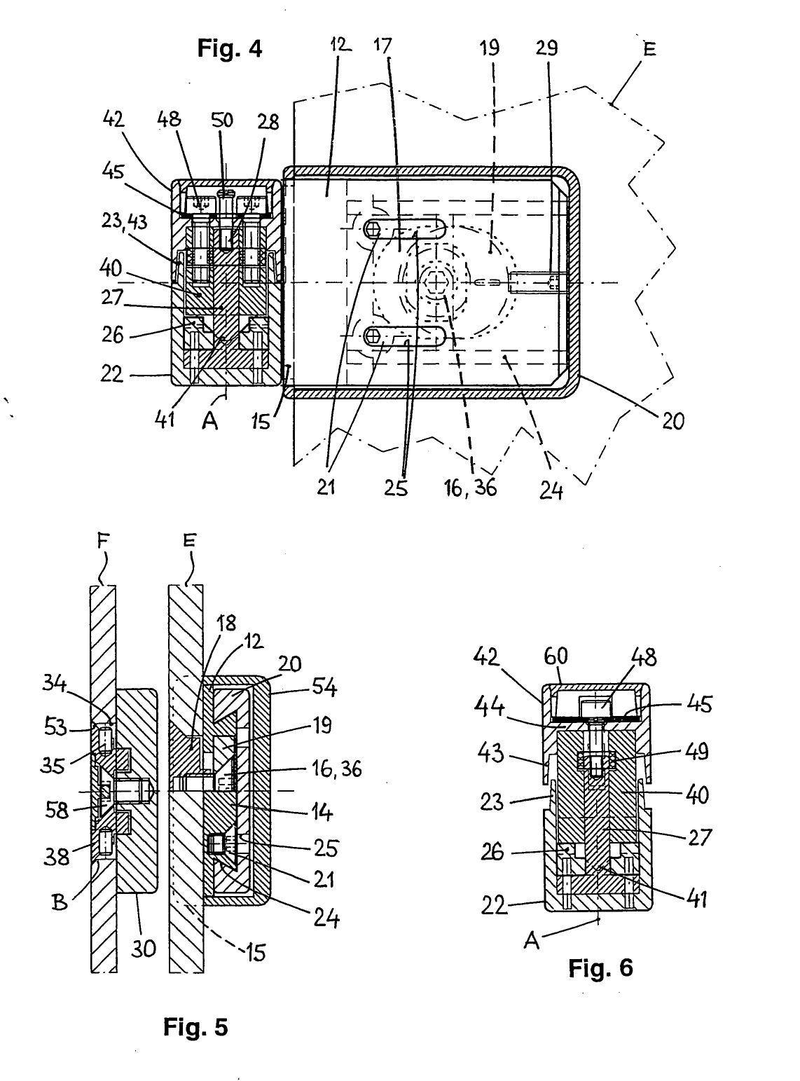

FIG. 4 is a vertical cross section parallel to the plane of a stationary glass door element through the hinge of FIG. 3a in closed position,

FIG. 5 is a vertical cross section across the plane of a stationary glass door element through the hinge of FIG. 4,

FIG. 6 is a vertical cross section through sleeve members of the hinge of FIG. 4 and FIG. 5, respectively, with the door leaf member in lifted position,

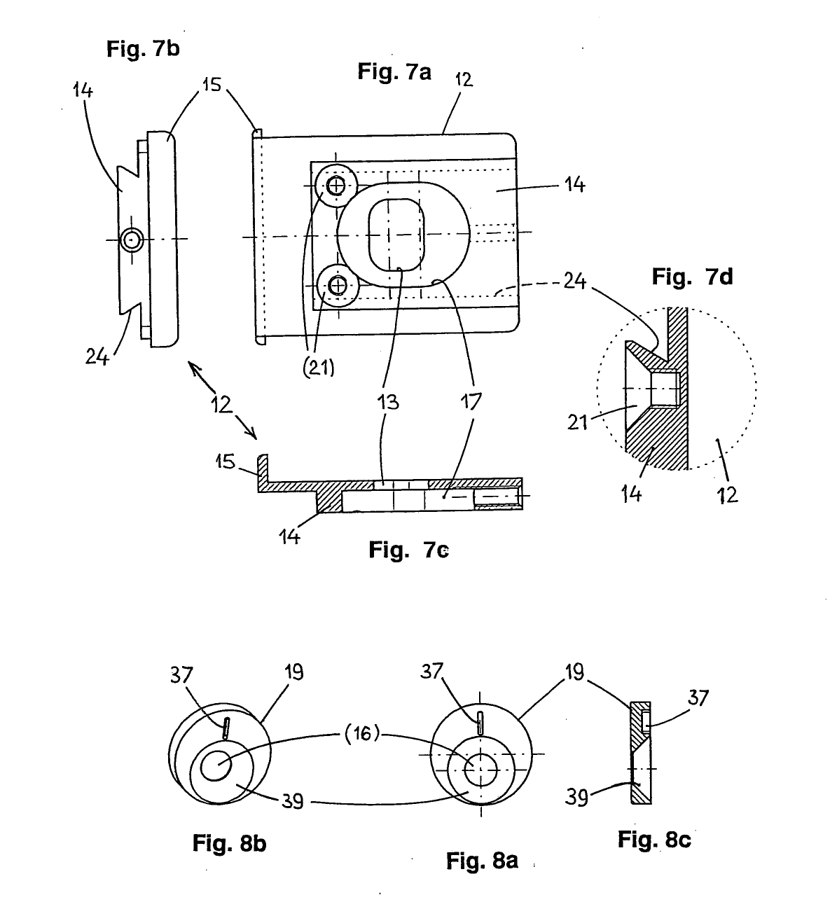

FIG. 7a, b, c are a plan view, a front view and a horizontal cross section view, respectively, of a clamping plate,

FIG. 7d is an enlarged sectional view of a vertical partial cross section through the clamping plate of FIG. 7a in the area of a clamping screw,

FIG. 8a, b, c are a plan view, an oblique view and a vertical cross section view, respectively, of an eccentric disk,

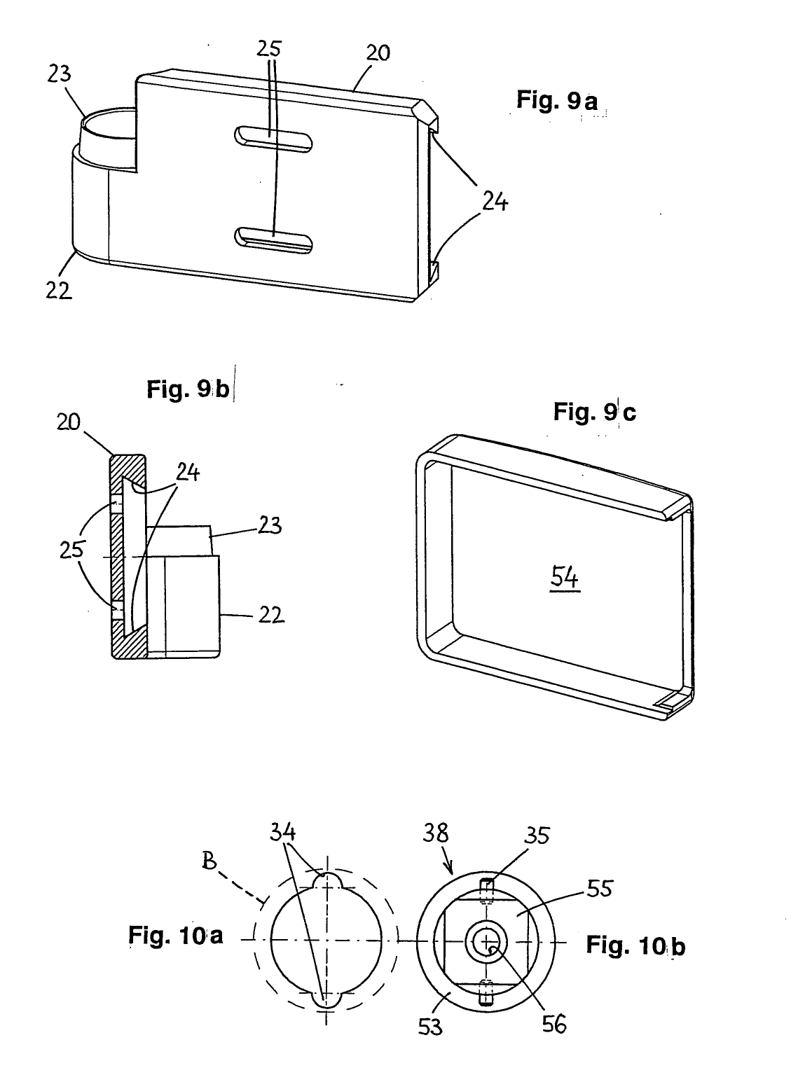

FIG. 9a is an oblique view of a hinge housing member, taken from the front and from outside, respectively,

FIG. 9b is a front view, partially in form of a vertical cross section, of the housing member of FIG. 9a,

FIG. 9c is an oblique interior view of a cap for the housing member of FIG. 9a,

FIG. 10a is the view of a borehole in a glass door leaf,

FIG. 10b is the view of a clamping disk to be inserted in the borehole of FIG. 10a,

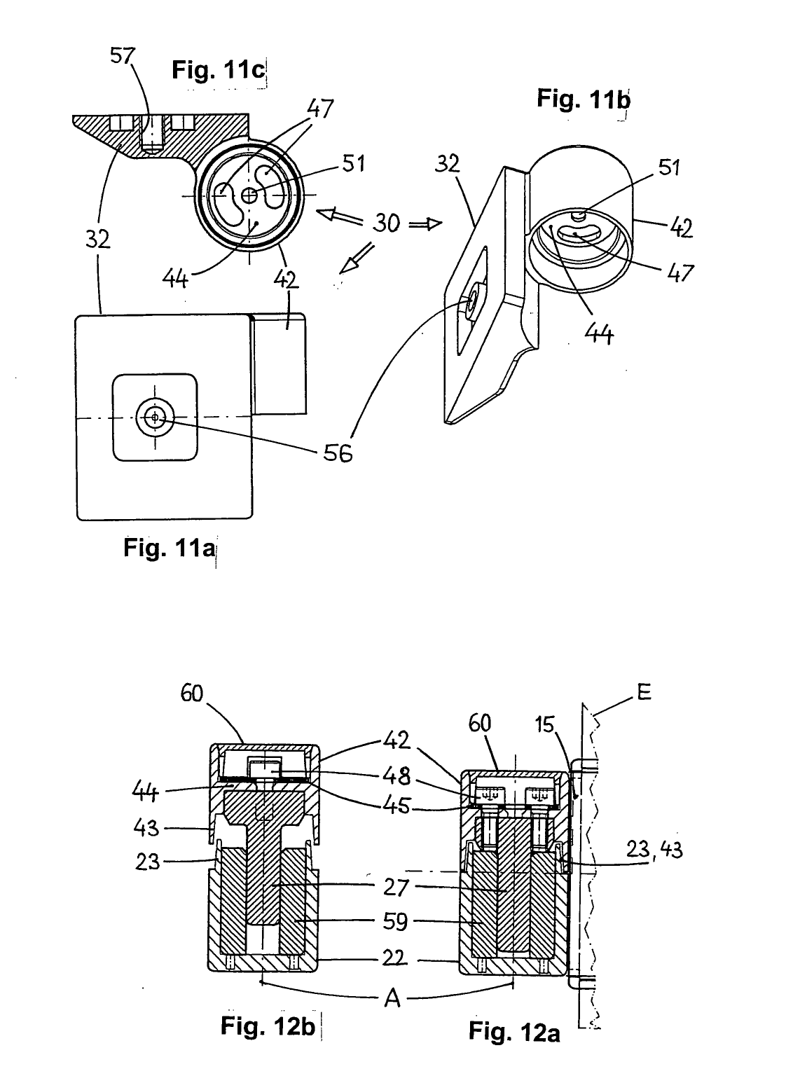

FIG. 11a, b, c are a rear view, an oblique view and a horizontal cross section view, respectively, of a hinge leaf part,

FIG. 12a is a vertical cross section through a modified sleeve arrangement in closed position similar to FIG. 4, and

FIG. 12b is a vertical cross section according to FIG. 12a, yet with the upper sleeve member in lifted position.

FIG. 1 shows a door hinge consisting of a stationary hinge member 10, a hinge housing member 20 and a hinge leaf member 30 as main components. The stationary hinge member 10 is fastened to a stationary glass door element E by means of an end-stop clamping plate 12 and a first clamping disk 18. It is covered by a hinge housing member 20. Said hinge housing member 20 comprises a lower sleeve member 22 sitting flush with an upper sleeve member 42 of the hinge leaf member 30 that is attached to a glass door leaf F by means of a second clamping disk 38. A sealing lip D, running along the vertical edge H of the door leaf F, prevents the penetration of splash water between the door element E and the door leaf F.

FIG. 2a and FIG. 2b illustrate that the hinge housing member 20 may be covered by a cap 54, possibly a slightly convex cap. As the hinge housing member 20 is placed on the end-stop clamping plate 12 in a way that permits displacements within a limited range, the rotation and pivoting axis A (see FIG. 3a, 3b, e.g.), respectively, defined by the two sleeve members 22, 42, can be shifted, if necessary. FIG. 2a shows a position in which the sleeve members 22, 42 are close to a fold 15 that forms a single unit with the end-stop clamping plate 12 and that is closely attached to the vertical edge H of the door element E. In the case of FIG. 2b, however, the sleeve members 22, 42 are located at a horizontal distance from the fold 15, since the housing member 20 is shifted to its (left) limit position.

The schematic illustration of FIG. 2c shows the hinge in open position, with the upper sleeve member 42 in a lifted position with respect to the lower sleeve member 22. That is because an interlocking means 40, located in the interior of the two sleeve members, has downward directed nibs 41 that rise on the ribs of a ribbed collar 26 in the lower sleeve member 22 when the door leaf F and consequently the hinge leaf member 30 are pivoted and thus facilitate the movement of the door leaf by lifting the bottom edge of the door leaf F.

Details of the structure and the function are evident from FIG. 3a and FIG. 3b. It can be seen that the end-stop clamping plate 12 forms a single unit with a lower member 14 that comprises an oblong recess 17 to receive a bearing 16 with a bearing screw 36 which fixes the first clamping disk 18 in a borehole B of the stationary door element E. The bearing screw 36 has a countersunk head that engages in a countersunk hole 39 of an adjustment excenter 19. By rotating said adjustment excenter, the bearing 16 can be adjusted in height and in width, with the oblong recess 17 additionally ensuring a clearance that permits to shift the hinge housing member 20 on the support body 14 to which said bearing is connected by means of a dovetail guide. A headless set screw 29 serves to fix the excenter 19 in the desired position.

The hinge leaf member 30 is fixed in a borehole B of the door leaf F by means of a second clamping disk 38. The base 32 of the hinge leaf member 30 forms a single unit with the upper sleeve member 42 that ensures a flush interengagement with the lower sleeve member 22 (here not visible).

It can be seen in FIG. 3a that the fold 15 surrounding the stationary door element E sits close to the upper sleeve member 42 when the hinge leaf member 30 is in closed position. The dotted line illustrates the open position in which the door leaf F is completely turned, i. e. pivoted by 180°. Intermediate positions are illustrated in FIG. 3b. There, the adjustment is such that the hinge housing member 20, including the lower sleeve member 22, is laterally shifted (to the left) with respect to the end-stop clamping plate 12, including the support body 14. Such a correction may be necessary to compensate local dimensional inaccuracies.

It is evident from the illustrations in FIG. 4 and FIG. 5 how the components 12/14 are fastened to the component 20. In particular it can be seen that the excenter 19 is arranged within the oblong recess 17 in a way that permits to adjust it in width and in height, so that the clamping support plate 12, that is maintained in contact with the door element E by means of the fold 15, abuts in an adjustable manner by means of the first clamping disk 18 and the bearing screw 36. As soon as a desired end position has been found, clamping screws 21, accessible by using a tool through slots 25 in the hinge housing member 20, can be unscrewed from their seat, detaching thus the housing member 20 from the support body 14 and clamping it in the dovetail guide 24. The movable door leaf F is adjusted by means of the flush sleeve members 22, 42, so that the fastening of the hinge leaf member 30 only requires the rigid fixation by means of the second clamping disk 38. Said clamping disk 38, however, must be prevented from rotating, which can be reached, for instance, by providing the borehole B in the door leaf F with two circumferential recesses 34 that interengage with the projections 35 of the second clamping disk 38. That is even more evident from FIG. 10a and FIG. 10b.

FIG. 6 shows the sleeve pair 22, 42 in the open position of the hinge, so that the upper sleeve member 42 is in a lifted position. It is particularly apparent here that the two sleeve members 22, 42 are provided with form-fitted sleeve collars 23, 43 that constitute a sliding bearing when the hinge is in closed position. On the bottom side, the lower sleeve member 22 comprises the ribbed collar 26 that is penetrated by the center pin 27 adapted to guide inside the interlocking means 40. When the door leaf F and consequently the hinge leaf member 30 are pivoted, its nibs 41 engage in different angle positions (see FIG. 2c). Furthermore it is provided that the interlocking means 40 is axially fixed to a transverse wall 44 of the upper sleeve member 42, namely by means of fixation screws 48 that penetrate a disk 45 above the transverse wall 44 and engage in a screw socket 49 in the interlocking means 40. As the transverse wall 44 is provided with two diametrical curved openings 47 (FIG. 11b and FIG. 11c), an additional angle adjustment of the hinge leaf member 30 can be made.

Further details of the structure can be seen in FIG. 7a to FIG. 11c. It is particularly apparent that the end-stop clamping plate 12 comprises an opening 13 that permits the passage of the bearing 16, and that the excenter 19 comprises, for the same purpose, the countersunk hole 39. It may comprise a cavity 37 adapted for the application of a tool to rotate it.

It is apparent from FIG. 9c that the particularly slightly convex cap 54 is adapted to be easily put over the hinge housing member 20 when reversed. For this purpose, it may additionally be provided with engagement means (not illustrated).

As it is already apparent from FIG. 3a, 3b, 5, the clamping disks 18, 38 comprise a cylindrical section each to be inserted into the cylindrical part of the related borehole B, whereas a conical collar 53 ensures their tight fit in the respective countersinkings of the boreholes B. Furthermore it is apparent from FIG. 10b that the second clamping disk 38 also comprises an intermediary means 55 provided with a hole 56 that permits to screw the screw 58 into the base 32.

In the embodiment of FIG. 12a and FIG. 12b, the lower sleeve member 22 comprises a guide bush 59 to guide the center pin 27 which in this case is attached to the transverse wall 44 of the upper sleeve member 42 by means of the fixation screws 48. A cover 60 may be positioned on the top of the upper sleeve member 42.

The present invention is not restricted to any of the embodiments described above but may be modified in diverse ways. It is seen that a hinge to be attached to shower enclosure elements made of flat material such as glass, plastics or the like, whose door elements E, F are provided, close to a vertical edge H, with boreholes B to receive door hinge parts 18, 38, preferably consists of three main components. A stationary hinge member 10 has an end-stop clamping plate 12 with a support body 14 comprising a two-dimensionally adjustable bearing 16 for a first clamping disk 18 attachable to a door element E. A hinge housing member 20, forming a single unit with a lower sleeve member 22 or being rigidly connected with the latter, is suitable to be attached thereto in a way that permits displacements within a limited range. A hinge leaf member 30 has a recess in a base 32, forming a single unit with an upper sleeve member 42 or being rigidly connected with the latter, to receive in a form-fitting way projections 35, a second clamping disk 38 adapted to be fixed in a borehole B of the door leaf F. The hinge leaf member 30, running on the stationary hinge member 10, is height adjustable within a limited range, with the lower sleeve member 22 and the upper sleeve member 42 forming a flush interengagement. The end-stop clamping plate 12 and the housing member 20 are connected by means of a detachable dovetail guide 24 to form a shiftable unit. The end-stop clamping plate 12 comprises on one of its narrow edges a ledge, a fold 15 or the like that sits close to a vertical edge H of the stationary door element E when fastened. An oblong recess 17 in the support body 14 is adapted to receive in a selectable position an adjustment excenter 19 that is screwed with the first clamping disk 18. The support body 14 may be wedged against the latter to fix the housing member 20. The hinge leaf member 30 is adapted to engage, with respect to the stationary member 10, in preferred pivoting positions. For this purpose, an interlocking means 40 located in the upper sleeve member 42 interengages with a ribbed collar 26 located in the lower sleeve member 22. The stationary member 10 and the leaf member 30 may be connected in a detachable manner through an axial retaining unit 27, 50, with the center pin 27 constituting an additional guiding device.

All of the features and advantages, including structural details and spatial arrangements, disclosed in the claims, the description and the drawings can be essential to the invention both independently and in great variety of combinations.

### REFERENCE SIGNS

A axis
B boreholes
D sealing lip
E stationary door element
F door leaf
H vertical edge
10 stationary hinge member
12 end-stop clamping plates
13 opening
14 support body
15 fold/ledge
16 bearing
17 oblong recess
18 first clamping disk
19 adjustment excenter
20 hinge housing member
21 clamping screws
22 lower sleeve member
23 sleeve collar
24 guide edges
25 slots
26 ribbed collar
27 center pin
28 tapped blind hole
29 headless set screw
30 hinge leaf member
32 base
34 recess
35 projections
36 bearing screw
37 cavity
38 second clamping disk
39 countersunk hole
40 interlocking means
41 nibs
42 upper sleeve member
43 sleeve collar
44 transverse wall
45 disk
46 axial projections
47 curved openings
48 fixation screws
49 screw socket
50 securing screw
51 borehole
53 conical collar
54 cap
55 intermediate means
56 hole
57 tapped hole
58 screw
59 guide bush
60 cover

1. Hinge to be attached to room enclosure devices, in particular shower enclosure units, comprising at least one stationary door element (E) and at least one door leaf (F) adjacent the latter, consisting of flat material such as glass, plastics or the like, and having boreholes (B) close to a vertical edge (H) to receive door hinge parts (18, 38), wherein:
a) a stationary hinge member (10) comprises an end-stop clamping plate (12) with a support body (14) which has or constitutes a two-dimensionally adjustable bearing (16) for a first clamping disk (18) adapted to be fixed in a borehole (B) of a stationary door element (E), and on which a hinge housing member (20), forming a single unit with a lower sleeve member (22) or being rigidly connected with the latter, is adapted to be placed and shifted within a limited range,
b) a hinge-member (30) comprises a base (32) with a recess (34) to receive in a form-fitting manner projections (35) of a second clamping disk (38) that is adapted to be fixed in a borehole (B) of the door leaf (F), and additionally comprises an upper sleeve member (42) that forms a single unit with the base (32) or is rigidly connected with the latter,
c) the hinge-leaf member (30), running on the stationary hinge member (10), is height adjustable within a limited range, with the lower sleeve member (22) and the upper sleeve member (42) interlocking with their parts (23, 43) that face each other.

2. Hinge according to claim 1, wherein the end-stop clamping plate (12) and the hinge housing member (20) are connected by means of a detachable guiding device to form a shiftable unit.

3. Hinge according to claim 1, wherein the support body (14) is an undercut broad rib which protrudes the end-stop clamping plate (12) and to which undercut guide edges (24) of the hinge housing member (20) are attached.

4. Hinge according to claim 1, wherein the end-stop clamping plate (12) is rectangular and comprises on one of its narrow edges a ledge, a fold (15), or the like that sits close to a vertical edge (H) of the stationary door element (E) when mounted.

5. Hinge according to claim 4, wherein the fold (15) is directed away from the support body side of the end-stop clamping plate (12).

6. Hinge according to claim 4, wherein the fold (15) constitutes a stopper for the pivoting range of the hinge leaf member (30).

7. Hinge according to claim 3, wherein the support body (14) comprises an oblong recess (17) that is adapted to receive in a selectable position an adjustment excenter (19) screwed with the first clamping disk (18).

8. Hinge according to claim 7, wherein the support body (14) is provided with at least one radial screw, e. g. a headless set screw (29), to be wedged against the circumference of the adjustment excenter (19).

9. Hinge according to claim 7, wherein the support body (12) comprises, in addition to the oblong recess (17), clamping means for fixing the hinge housing member (20).

10. Hinge according to claim 9, wherein the clamping means consist of at least one screw (21) positioned in the support body (14) in vertical direction to the plane of the latter suitable to be tightened and loosened by applying a tool through an opening (25) in the hinge housing member (20).

11. Hinge according to claim 10, wherein the hinge housing member (20) comprises two parallel oblong holes (25) opposite the heads of two screws (21).

12. Hinge according to claim 1, wherein the hinge housing member (20) is provided with a cover means, especially with a detachable and removable cap (54).

13. Hinge according to claim 1, wherein the hinge leaf member (30) is adapted to engage, with respect to the stationary hinge member (10), in preferred pivoting positions.

14. Hinge according to claim 13, wherein the hinge housing member (20) in the lower sleeve member (22) comprises a ribbed collar (26) that interengages with projections (46) of an interlocking means (40) located on or in the upper sleeve member (42).

15. Hinge according to claim 14, wherein the interlocking means (40) is a cylindrical element, positioned in the upper sleeve member (42) and provided with in downward direction axially aligned projections (46).

16. Hinge according to claim 14, wherein the interlocking means (40) is attached to a disk (45) that is placed in the upper sleeve member (42) in a way that permits rotations within a limited range around the axis (A) of the latter.

17. Hinge according to claim 16, wherein the disk (45) is placed on a transverse wall (44) in the upper sleeve member (42) that is provided with oblong holes (47) in the bottom segment which are penetrated, parallel to the axis, by fixation screws (48) for the interlocking means (40).

18. Hinge according to claim 1, wherein the stationary hinge member (10) and the hinge leaf member (30) are connected in a detachable manner through an axial retaining means (27, 50).

19. Hinge according to claim 18, wherein the retaining means is composed of a center pin (27) forming a single unit with the lower sleeve member (22) or being rigidly connected with the latter and having a tapped blind hole (28) on the front side, and a screw (50) that penetrates a transverse wall (44) in the upper sleeve member (42) and engages in said tapped blind hole.

20. Hinge according to claim 19, wherein the center pin (27) constitutes an additional guiding device for the lower sleeve member (10) and the upper sleeve member (42).

21. Hinge according to claim 1, wherein the sleeve collars (23, 43) of the lower sleeve member (22) and the upper sleeve member (42) interengage axially with little clearance.

22. Hinge according to claim 1, wherein the clamping disks (18, 38) comprise a cylindrical section each, located in the related borehole (B) of the stationary door element (E) and the door leaf (F), and an adjacent conical collar (53) to be inserted into form-fitting countersinkings of the borehole.
